(19) United States
(12) Patent Application Publication
(10) Pub. No.: US 2026/0180860 A1
(43) Pub. Date: Jun. 25, 2026

(54) HANDLING OF ASYNCHRONOUS RECEPTION OF QUALITY OF EXPERIENCE CONFIGURATION IN MASTER NODE AND SECONDARY NODE

(71) Applicant: Telefonaktiebolaget LM Ericsson (publ), Stockholm (SE)

(72) Inventors: Johan RUNE, LINDINGÖ (SE); Filip BARAC, HUDDINGE (SE); Vengatanathan KRISHNAMOORTHI, LINKÖPING (SE); Luca LUNARDI, GENOVA (IT)

(73) Assignee: Telefonaktiebolaget LM Ericsson (publ), Stockholm (SE)

(21) Appl. No.: 19/129,369

(22) PCT Filed: Nov. 13, 2023
(86) PCT No.: PCT/SE2023/051148

§ 371 Date: May 13, 2025

Related U.S. Application Data
(60) Provisional application No. 63/425,590, filed on Nov. 15, 2022.

(51) Int. Cl. H04L 41/0866; H04L 41/5019

(52) U.S. Cl. CPC H04L 41/0866; H04L 41/5019

(57) ABSTRACT

A first network node in a communications network that includes a second network node is provided. The first network node and the second network node provide dual connectivity, DC, for a communication device. The first network node can receive an indication of whether the second network node has obtained configuration information associated with the communication device. The configuration information can include quality of experience, QoE configuration information and/or radio access network visible QoE, RVQoE, configuration information. The first network node can determine whether to transmit the configuration information associated with the communication device based on the indication of whether the second network node has obtained the configuration information.

### TECHNICAL FIELD

The present disclosure is related to wireless communication systems and more particularly to handling of asynchronous receptions of quality of experience (“QoE”) configuration in master node (“MN”) and (“SN”).

### BACKGROUND

FIG. 1 illustrates an example of current 5^{th} generation radio access network (“NG-RAN”) architecture. The NG-RAN architecture can be further described as follows. The NG-RAN includes a set of 5^{th} generation (“5G”) base stations (referred to herein as gNBs) connected to the 5^{th} generation core network (“5GC”) through the next generation (“NG”) interface. A gNB can support frequency division duplex (“FDD”) mode, time division duplex (“TDD”) mode or dual mode operation. gNBs can be interconnected through the Xn-C interface. A gNB can include a gNB-central unit (“CU”) and gNB-distributed units (“DUs”). A gNB-CU and a gNB-DU are connected via a F1 logical interface. One gNB-DU is connected to only one gNB-CU. For resiliency, a gNB-DU may be connected to multiple gNB-CU by appropriate implementation. NG, Xn-C, and F1 are logical interfaces. The NG-RAN is layered into a Radio Network Layer (“RNL”) and a Transport Network Layer (“TNL”). The NG-RAN architecture (e.g., the NG-RAN logical nodes and interfaces between them) is defined as part of the RNL.

For each NG-RAN interface (e.g., NG, Xn-C, and F1) the related TNL protocol and the functionality are specified. The TNL provides services for user plane transport and signaling transport.

For NG-RAN, the NG and Xn-C interfaces for a gNB consisting of a gNB-CU and gNB-DUs, terminate in the gNB-CU. For EN-DC, the S1-U and X2-C interfaces for a gNB including a gNB-CU and gNB-DUs, terminate in the gNB-CU. The gNB-CU and connected gNB-DUs are only visible to other gNBs and the 5GC as a gNB.

A gNB may also be connected to a long term evolution (“LTE”) base station (referred to herein as an eNB) via an X2 interface. Another architectural option is that where an LTE eNB connected to the Evolved Packet Core network is connected over the X2 interface with a so called nr-gNB. The latter is a gNB not connected directly to a core network (“CN”) and connected via X2 to an eNB for the sole purpose of performing dual connectivity.

The architecture in FIG. 1 can be expanded by splitting the gNB-CU into two entities: one gNB-CU-user plane (“UP”), which serves the user plane and hosts the packet data convergence protocol (“PDCP”) and one gNB-CU-control plane (“CP”), which serves the control plane and hosts the PDCP and radio resource control (“RRC”) protocol. A gNB-DU hosts the radio link control (“RLC”)/media access control (“MAC”)/physical layer (“PHY”) protocols.

Other standardization groups, such as the open radio access network (“ORAN”), have further extended the architecture above and have for example split the gNB-DU into two further nodes connected by a fronthaul interface. The lower node of the split gNB-DU can include the PHY protocol and the radio frequency (“RF”) parts, the upper node of the split gNB-DU can host the RLC and MAC. In ORAN the upper node is called O-DU, while the lower node is called O-RU.

An NG-RAN can also include a set of ng-eNBs, an ng-eNB can include an ng-eNB-CU and one or more ng-eNB-DU(s). An ng-eNB-CU and an ng-eNB-DU can be connected via a W1 interface. While this disclosure may refer generally to gNBs, the general principles may apply to other radio access technologies, for example, the principles may apply to a ng-eNB and W1 interface.

FIG. 2 illustrates an example of an architecture for separation of gNB-CU-CP and gNB-CU-UP. A gNB may consist of a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the El interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

In dual connectivity a UE capable of multiple transmission/receptions, may be connected to more than one RAN node. The RAN nodes may be of the same RAT (both master node and secondary node in NR or LTE respectively) or different RATs, for example one master LTE node and one secondary NR node.

### SUMMARY

According to some embodiments, a method of operating a first network node in a communications network that includes a second network node is provided. The first network node and the second network node provide dual connectivity (“DC”) for a communication device. The method includes receiving an indication of whether the second network node has obtained configuration information associated with the communication device. The configuration information includes quality of experience (“QoE”) configuration information and/or radio access network visible QoE (“RVQoE”) configuration information. The method further includes determining whether to transmit the configuration information associated with the communication device based on whether the second network node has obtained the configuration information.

According to other embodiments, a first network node, a second network node, a computer program, a computer program product, a non-transitory computer readable medium, host, or system is provided to perform the above method.

Certain aspects of the disclosure and their embodiments may provide technical advantages. Some embodiments here are able to handle situations in which both the MN and the SN in a DC setup for a UE have cells within the area scope of a certain management-based QoE configuration. If both the MN and SN in a DC setup for a UE have cells within the area scope of a certain management-based QoE configuration, the MN and the SN will not receive the management-based QoE configuration from the OAM system simultaneously. In some embodiments, a procedure is described that uses asynchronous coordination between the MN and the SN of management-based QoE configuration in conjunction with dual connectivity.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a next generation radio access network (“NG-RAN”) overall architecture;

FIG. 2 is a schematic diagram illustrating an example of an overall architecture for separation of a gNB-central unit-control plane (“CU-CP”) and gNB-central unit-user plane (“CU-UP”);

FIG. 3 is a diagram illustrating an example of an ASN.1 code for a MeasurementReportAppLayer;

FIG. 4 is a table illustrating an example of MeasurementReportAppLayer field descriptions;

FIG. 5 is a table illustrating an example of +CAPPLEVMCNR parameter command syntax;

FIG. 6 is a table illustrating an example of +CAPPLEVMR parameter command syntax;

FIG. 7 is a block diagram illustrating an example of dual connectivity combined with carrier aggregation in MR-DC;

FIG. 8 is a block diagram illustrating an example of EN-DC architecture;

FIG. 9 is a schematic diagram illustrating an example of EN-DC architecture;

FIG. 10 is a block diagram illustrating an example of NR-DC architecture;

FIG. 11 is a flow chart illustrating an example of operations performed by a network node in accordance with some embodiments

FIG. 12 is a block diagram of a communication system in accordance with some embodiments;

FIG. 13 is a block diagram of a user equipment in accordance with some embodiments

FIG. 14 is a block diagram of a network node in accordance with some embodiments;

FIG. 15 is a block diagram of a host, which may be an embodiment of the host of FIG. 12, in accordance with some embodiments;

FIG. 16 is a block diagram of a virtualization environment in accordance with some embodiments; and

FIG. 17 shows a communication diagram of a host communicating via a network node with a user equipment over a partially wireless connection in accordance with some embodiments.

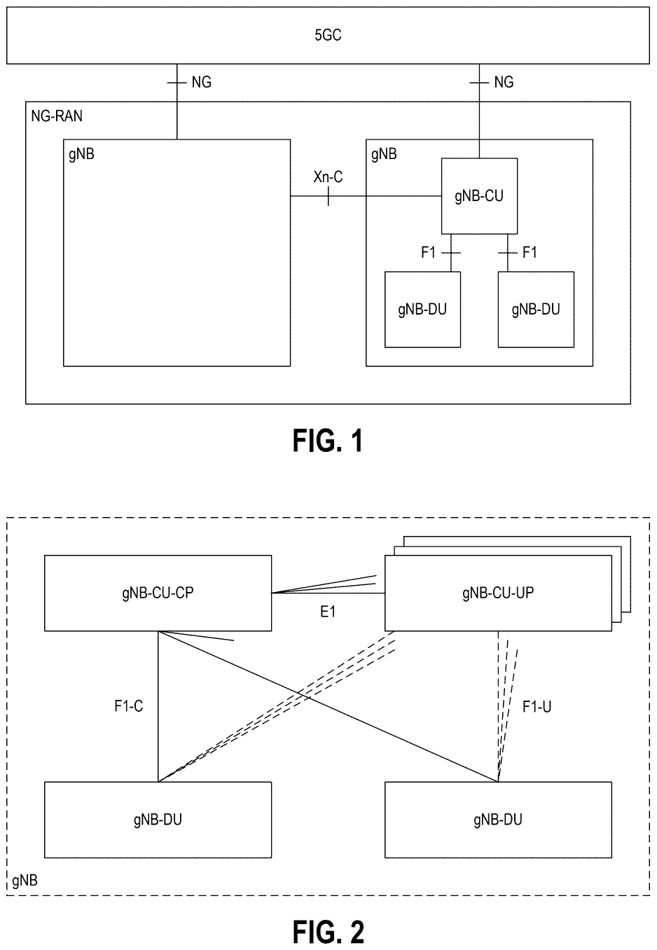

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

A quality of experience (“QoE”) measurements (sometimes referred to as “application layer measurements”) have been specified for long term evolution (“LTE”), universal mobile telecommunications system (“UMTS”) and were recently specified for fifth generation (“5G”) new radio (“NR”) in the third generation partnership project (“3GPP”) Rel-17. A purpose of the QoE measurements is to measure the experience of the end user using certain applications. Currently the QoE measurements are specified and supported for DASH streaming, mobility telephony service for internet protocol multimedia subsystem (“MTSI”) services, and virtual reality (“VR”).

The solutions in LTE and UMTS are similar with the overall principles as follows. QoE Measurement Collection (“QMC”) enables configuration of application layer measurements in the user equipment (“UE”) (also referred to as a communication device) and transmission of QoE measurement result files, commonly referred to as “QoE reports”, to the network by means of radio resource control (“RRC”) signaling. An application layer measurement configuration (also called QoE measurement configuration or QoE configuration) that the radio access network (“RAN”) receives from the operations, administration, and maintenance (“OAM”) system, or the core network (“CN”), is encapsulated in a transparent container, which is forwarded to a UE in a downlink RRCReconfiguration message. An application layer measurement report (also called QoE report) that the UE Access Stratum (“AS”) or UE RRC layer receives from the UE's higher layer (application layer) is encapsulated in a transparent container and sent to the network in an uplink RRC message, MeasurementAppLayerReport. The RAN then forwards the QoE report to a Measurement Collector Entity (“MCE”).

The third generation partnership project (“3GPP”) has indicated that QoE management in NR will not just collect the QoE parameters of streaming services but also consider the typical performance requirements of diverse services (e.g., augmented reality (“AR”)/virtual reality (“VR”) and ultra-reliable low latency communication (“URLLC”), of which at least VR was covered in 3GPP Rel-17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an internet protocol (“IP”) address of the entity the collected measurement results (i.e. the QoE reports) should be sent to (often referred to as a MCE) and a set of instructions of which type of measurements that should be performed and details of how these measurements are to be performed. These instructions are intended for the application layer in the UE and are placed in a “container” which cannot be read and interpreted by the network entities handling it, e.g., forwarding it to the UE, as well as the UE Access Stratum. The currently specified service types are MTSI and streaming service (DASH), and in 3GPP Rel-17, VR was added. An area scope is defined in terms of cells or network related areas. In UMTS, an area scope is defined as either a list of cells, a list of routing areas, or a list of tracking areas. In LTE, an area scope is defined as either a list of cells or a list of tracking areas. In NR, an area scope is defined as either a list of cells (a list of NCGIs) or a list of tracking areas (a list of TACs).

QoE, and in particular, the QoE configuration, comes in two types: management-based (m-based) QoE configuration and signaling-based (s-based) QoE configuration. In both cases the QoE configuration originates in the OAM system or some other administrational entity, e.g., dealing with customer satisfaction. All of these entities are in this document referred to as the OAM system (where the OAM system also contains further entities).

With the m-based QoE, the OAM system is typically interested in general QoE statistics from a certain area, configured as an area scope. The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With the s-based QoE, the OAM system is interested in collecting QoE measurement results from a specific UE, e.g., because the user of the UE has filed a complaint. The OAM system sends the s-based QoE configuration to the home subscriber server (“HSS”) (in evolved packet system (“EPS”)/LTE) or unified data management (“UDM”) (in 5GS/NR), which forwards the QoE configuration to the UE's current core network node (e.g., an mobility management entity (“MME”) in EPS/LTE or an access and mobility management function (“AMF”) in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality is logically separated from the Trace functionality, but it will still partly reuse the Trace signaling mechanisms. In NR, and possibly in LTE, a globally unique QoE reference (formed of mobile country codes (“MCC”) +mobile network codes (“MNC”) +QMC identifier (“ID”), where the QMC ID is a string of 24 bits) will be associated with each QoE configuration. The QoE reference is included in the container with measurement instructions and also sent to the RAN (e.g., the gNB in NR). For the communication between the gNB and the UE, the QoE reference is replaced by a shorter identifier denoted as measConfigAppLayerId, which is locally unique within a UE (e.g., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE reports are sent from the UE application layer to the UE Access Stratum, which forwards them to the RAN, which in turn forwards them to the MCE. These QoE reports are placed in a “container”, which is uninterpretable for both the UE Access Stratum and the RAN. QoE reporting can be configured to be periodic or only to be sent at the end of an application session. Furthermore, the RAN can instruct the UE to pause QoE reporting (e.g., in case the cell/gNB is in a state of overload).

The RAN is not automatically aware of when an application session with an associated QoE measurement session is ongoing, and the UE Access Stratum is also not automatically aware of this. To alleviate this session “start”/“stop” indications which are sent from the application layer in the UE to the UE AS and from the UE AS to the RAN were introduced. A session “stop” indication may be explicit or may be implicit in the form of a QoE report sent when the application session and the associated QoE measurement session are concluded.

The RAN may decide to release a QoE configuration in a UE at any time, as an implementation-based decision. Typically, it is done when the UE has moved outside a configured area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

QoE measurements, and their reported results, are intended for analysis in the O&M system (or in other entities that neither belong to the core network nor belong to the RAN) and subsequent possible non-real-time optimizations. The QoE reports are forwarded transparently by the RAN to a configured receiver, e.g. an MCE. However, the RAN could also benefit from receiving measurement results of metrics measured or collected at the application layer, e.g. as a complement to the more radio related measurements, i.e. the RRM measurements (e.g., RSRP, RSRQ, or SINR). For instance, the RAN could use such measurement results for real-time or semi-real-time adaptations or optimizations of the treatment of an ongoing application session, e.g. in terms of scheduling priorities.

For this reason, in 3GPP release 17, 3GPP introduced so-called RAN Visible QoE, which comprises periodic reporting of measured application layer metrics in a format that the RAN can understand. These metrics, denoted as RVQoE metrics, are in release 17 limited to QoE metrics, in particular the Buffer Level QoE metric for DASH (further described in TS 26.247 version 17.1.0 and TS 38.331 version 17.2.0) and the Playout Delay for Media Start-up QoE metric for DASH. In addition to these two RVQoE metrics, a MeasurementReportAppLayer message may contain a PDU session ID list (in the form of the pdu-SessionIdList-r17 field) as part of the reported RVQ information (i.e. in the RAN-VisibleMeasurements-r17 IE).

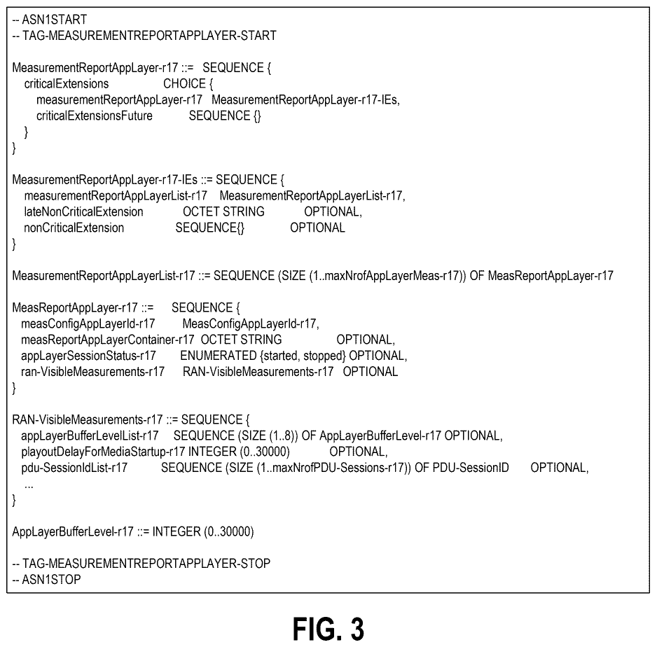

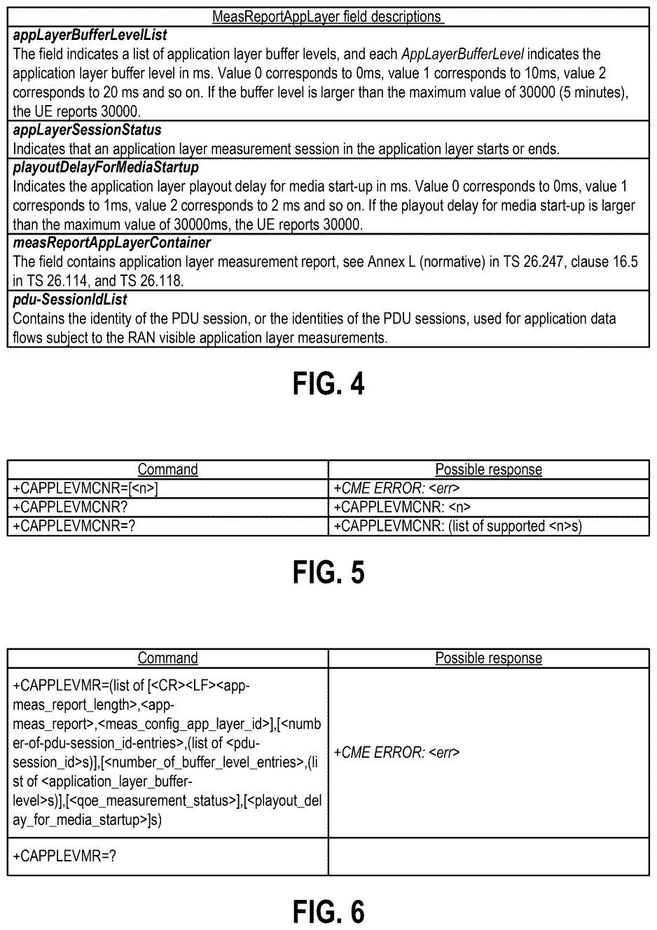

FIG. 3 illustrates an example of an ASN.1 code for a MeasurementReportAppLayer message (as further described in TS 38.331 version 17.2.0). A UE uses the MeasurementReportAppLayer message to report measured QoE metrics and measured RVQoE metrics. FIG. 4 illustrates an example of descriptions of the fields in the MeasurementReportAppLayer message (as further described in TS 38.331 version 17.2.0). In this example, the MeasurementReportAppLayer message includes an appLayerBufferLevelList field (e.g., indicating a list of application layer buffer levels), an appLayerSessionStatus field (e.g., indicating that an application layer measurement session in the application layer starts or ends), a playoutDelay ForMediaStartup field (e.g., indicating the application layer playout delay for media start-up), a measReportAppLayerContainer field (e.g., including an application layer measurement report), and a pdu-SessionIdList field (e.g., including an identity of the PDU session).

AT commands are used for communication between the AS (radio) layer and the application layer in the UE. The AT commands are used in QoE for transferring of the configuration from the RRC layer to the application and for transferring of reports from the application layer to the RRC layer.

The AT command used for sending a QoE configuration (and/or a RVQoE configuration) from the UE AS to the UE application layer in NR is denoted as +CAPPLEVMCNR and is specified as illustrated in FIG. 5 (and further described in TS 27.007 version 17.7.0). This command allows control of the application level measurement configuration.

The AT command used for sending QoE reports (and/or RVQoE reports) from the UE application layer to the UE AS in NR is denoted as +CAPPLEVMRNR and is specified as illustrated in FIG. 6 (and further described in TS 27.007 version 17.7.0). This command allows the MT to provide a list of application level measurement reports.

In LTE, the corresponding AT commands are denoted respectively as +CAPPLEVMC and +CAPPLEVMR (further description can be found in Table 8.84-1 and Table 8.85-1 of TS 27.007 version 17.7.0).

In 3GPP Rel-12, the LTE feature Dual Connectivity (DC) was introduced, to enable the UE to be connected in two cell groups, each controlled by an LTE access node, eNBs, labelled as the Master eNB, MeNB, and the Secondary eNB, SeNB. The UE only has one RRC connection with the network. In 3GPP, the Dual Connectivity (DC) solution has since then been evolved and is now also specified for NR as well as between LTE and NR. Multi-connectivity (MC) is the case when there are more than 2 nodes involved. With introduction of 5G, the term MR-DC (Multi-Radio Dual Connectivity) was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

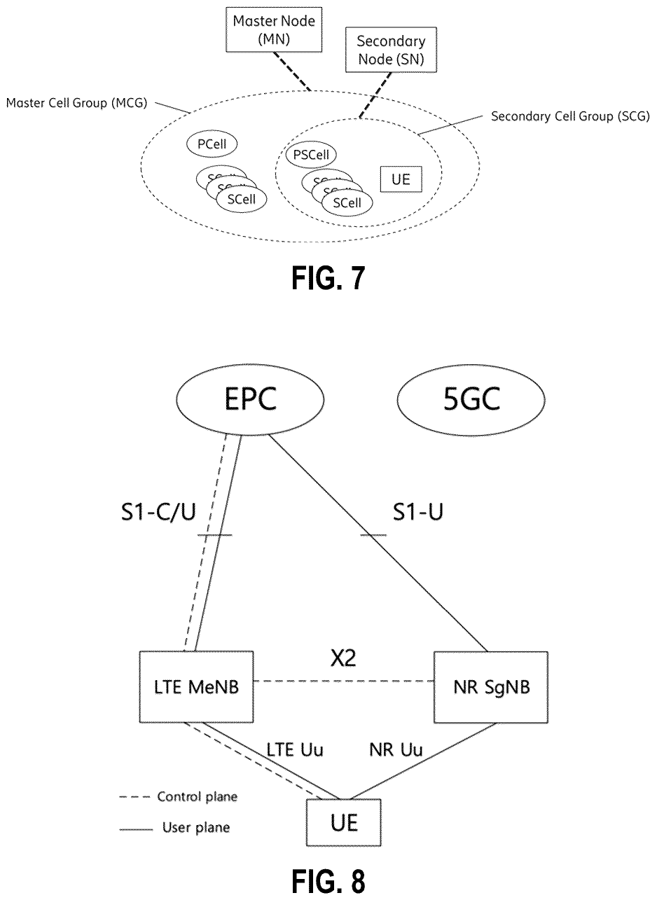

FIG. 7 illustrates an example of a dual connectivity combined with carrier aggregation in MR-DC. As illustrated, a master node (“MN”) can be configured to provide a master cell group (“MCG”) and a secondary node (“SN”) can be configured to provide a secondary cell group (“SCG”). In this example, within the MCG, the UE may use one PCell and one or more SCell(s). And within the SCG, the UE may use one Primary SCell (PSCell, also known as the primary SCG cell in NR) and one or more SCell(s). In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE (also referred to as E-UTRA) and evolved packet core (“EPC”). In principle, NR and LTE can be deployed without any interworking, denoted by NR stand-alone (“SA”) operation, also known as Option 2, that is gNB in NR can be connected to 5G core network (“5GC”) and eNB in LTE can be connected to EPC with no interconnection between the two, also known as Option 1.

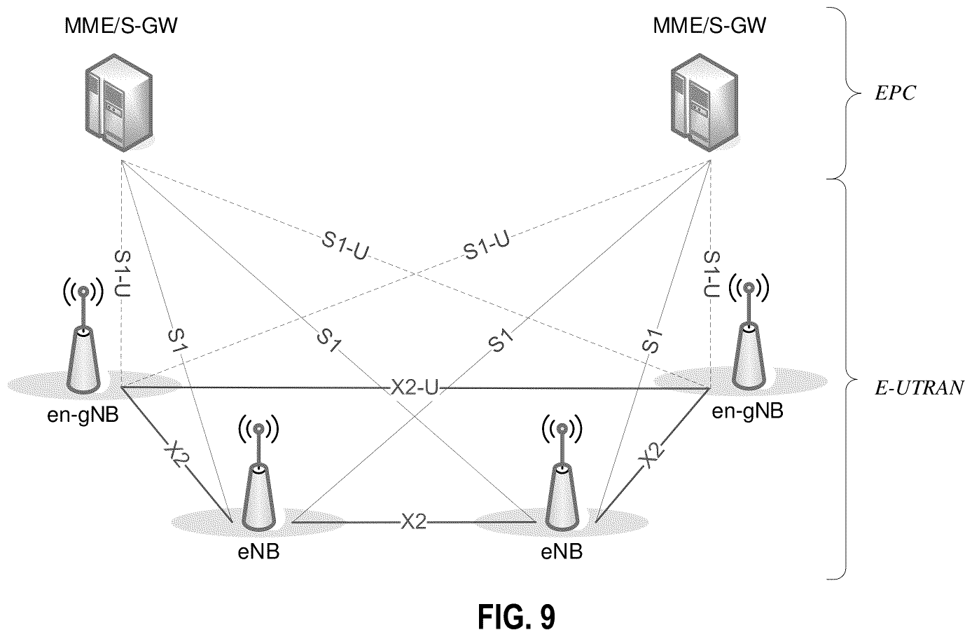

The first supported version of NR uses dual connectivity, denoted as EN-DC (E-UTRAN-NR Dual Connectivity), also known as Option 3, is depicted in FIG. 8. In such a deployment, dual connectivity between NR and LTE is applied, where the UE is connected with both the LTE radio interface (LTE Uu in FIG. 8) to an LTE access node and the NR radio interface (NR Uu in FIG. 8) to an NR access node. Further, in EN-DC, the LTE access node acts as the master node (in this case known as the Master eNB, MeNB), controlling the master cell group, MCG, and the NR access node acts as the secondary node (in this case sometimes also known as the Secondary gNB, SgNB), controlling the secondary cell group, SCG. The SgNB may not have a direct control plane connection to the core network (“EPC”). In this example, the SgNB has a control plane connection to the EPC via the LTE MeNB. This is also referred to as “Non-standalone NR” or, in short, “NSA NR”. Notice that in this case, the functionality of an NR cell (e.g., a cell in the MCG or SCG providing wireless communication via a NR RAT) is limited and would be used for connected mode UEs as a booster and/or diversity leg, but an RRC_IDLE UE cannot camp on these NR cells. FIG. 9 illustrates another example of Option 3, an EN-DC architecture.

With introduction of 5GC, other options may be also valid. As mentioned above, option 2 supports stand-alone NR deployment where gNB is connected to 5GC. Similarly, LTE can also be connected to 5GC using option 5 (also known as eLTE, E-UTRA/5GC, or LTE/5GC and the node can be referred to as an ng-eNB). In these cases, both NR and LTE are seen as part of the NG-RAN (and both the ng-eNB and the gNB can be referred to as NG-RAN nodes).

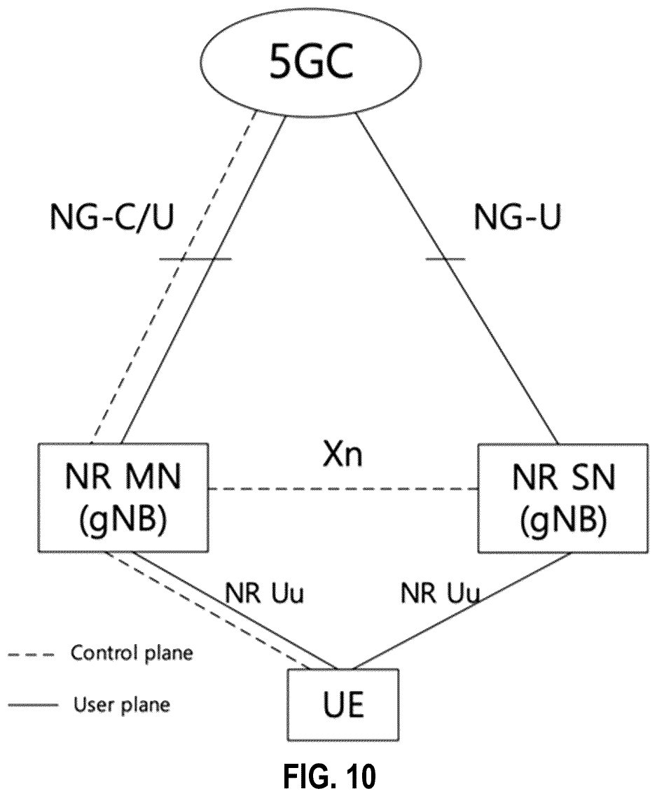

It is worth noting that, there are also other variants of dual connectivity between LTE and NR which have been standardized as part of NG-RAN connected to 5GC. The MR-DC umbrella includes: EN-DC (Option 3); NE-DC (Option 4); NGEN-DC (Option 7); and NR-DC (variant of Option 2). In EN-DC (Option 3), the LTE is the master node and NR is the secondary node (EPC CN employed, as depicted in FIGS. 8-9). In NE-DC (Option 4), the NR is the master node and LTE is the secondary (5GCN employed). In NGEN-DC (Option 7), the LTE is the master node and NR is the secondary (5GCN employed). In NR-DC (variant of Option 2), dual connectivity where both the master node, MN, controlling the MCG, and the secondary node, SN, controlling the SCG, are NR (5GCN employed, as depicted in FIG. 10). As illustrated in FIG. 10, the UE can communicate with the 5GC via a NR MN or a NR SN.

If the M-based QoE configuration is received by the MN, the MN should make the decision on the UE selection and on which node sends the QoE configuration to the UE.

If the M-based QoE configuration is received only by the SN, whether the MN or the SN performs UE selection and sends the QoE configuration to the UE needs to be further discussed.

If both MN and SN receive an m-based QoE configuration, the MN should decide on the UE selection and on which node sends the QoE configuration to the UE.

There currently exist certain challenges. When it comes to management-based QoE configuration in conjunction with NR-DC, where both the MN and the SN receive the management-based QoE configuration from the OAM system, the discussions, agreements and working assumptions in 3GPP have so far looked at scenarios where, the management-based QoE configuration has been available at both the MN and the SN when actions are considered, decided, and performed. However, in practice, even when the MN and the SN both have cells within the area scope of a certain management-based QoE configuration, the MN and the SN may not receive the management-based QoE configuration simultaneously from the OAM system. If the difference in the times of reception of the management-based QoE configuration is long enough that decisions on actions to be performed (including exchange of information, request and/or instructions between the MN and the SN, and/or sending of the management-based QoE configuration to the UE) are made, or gathering of input to the decision-making is initiated, before both nodes have received the management-based QoE configuration, this will impact what actions the nodes can perform and/or which actions are suitable to perform.

The above-described type of scenario, with a non-negligible difference between the times of reception of a management-based QoE configuration in the MN and the SN, are herein referred to asynchronous reception of management-based QoE configuration in the MN and the SN. Furthermore, in the context of this document, the term/concept asynchronous reception of management-based QoE configuration also comprises scenarios involving SN addition and SN change when the MN has a management-based QoE configuration. More specifically, in one such scenario, a UE is in single connectivity mode and its serving gNB has received a management-based QoE configuration, and subsequently (after a non-negligible time) the UE's serving gNB adds a SN (and thus itself becomes the MN). In another specific scenario, the UE is in DC mode and the MN (and possibly the SN) has received a management-based QoE configuration and subsequently (after a non-negligible time) the SN is changed (under the control of the MN).

It is a problem that such, very realistic scenarios, are not taken into account in 3GPP. This is what the invention addresses by proposing solutions for scenarios involving asynchronous reception of management-based QoE configuration in the MN and the SN.

Certain aspects of the disclosure and their embodiments may provide solutions to these or other challenges. Various embodiments herein address the problem of asynchronous reception of a management-based QoE configuration by the RAN nodes jointly providing dual connectivity (or multi-connectivity) to a UE. In some embodiments, procedures involving asynchronous coordination between the MN and the SN, tailored for specific scenarios of asynchronous reception of a management-based QoE configuration are provided.

In some embodiments, the network node determines whether the other node has received the management-based QoE configuration. In additional or alternative embodiments, the network node determines whether the other node will receive the management-based QoE configuration (if it has not already received it). In additional or alternative embodiments, the network node waits for the management-based QoE configuration to arrive at the other node and starts a timer that governs the maximum time the node will wait. In additional or alternative embodiments, the network node determines whether the UE is within the area scope (and/or in the slice scope) in the other node.

Various embodiments permit the MN and the SN in a DC setup for a UE to take into account that the MN and the SN may not receive a certain management-based QoE configuration from the OAM system simultaneously, but rather with a non-negligible delay which may impact the inter-node coordination with regards to the management-based QoE configuration. To this end, some embodiments include means, for the MN, to anticipate such difference in the times of reception of the management-based QoE configuration and adapt the coordinating actions accordingly.

In some embodiments, the MN determines whether the other node has received the management-based QoE configuration (e.g., based on lack of a message concerning the management-based QoE configuration from the other node). In additional or alternative embodiments, the MN determines whether the other node will receive the management-based QoE configuration (if it has not already received it). This may be determined from a list of served cells (including its NCGIs and/or TACs) in the other node, which may be compared with the definition of the area scope of the management-based QoE configuration. In additional or alternative embodiments, the network node waits for the management-based QoE configuration to arrive at the other node and starts a timer that governs the maximum time the node will wait. This is mainly relevant for the node that has the main responsibility for the coordination (e.g., the MN). In additional or alternative embodiments, the MN determines whether the UE is within the area scope (and/or the slice scope) in the other node. This may be done by determining whether the UE is connected in a cell within the area scope in the other node.

Many field (i.e. parameter) names or information element (“IE”) names in the radio resource control (“RRC”) configuration for new radio (“NR”) are referred to either as a name with a postfix indicating the Third Generation Partnership Project (“3GPP”) standard release (e.g. “-r17” indicating 3GPP release 17) or as the same name without the postfix. The version with the postfix is then used in the ASN.1 code, while the version without the postfix is used in other text in the specification. In this document, when applicable, the two versions of the name are used interchangeably. For instance, the names “AppLayerMeasConfig” and “AppLayerMeasConfig-r17” refer to the same IE.

A radio access network (“RAN” node can be a gNB, eNB, en-gNB, next generation (“ng”)-eNB, gNB-central unit (“CU”), gNB-CU-control plane (“CP”), gNB-CU-user plane (“UP”), eNB-CU, eNB-CU-control plane (“CP”), eNB-CU-UP, integrated access and backhaul (“IAB”)-node, IAB-donor distributed unit (“DU”), IAB-donor-CU, IAB-DU, IAB-mobile termination (“MT”), open-RAN (“O”)-CU, O-CU-CP, O-CU-UP, O-DU, O-RU, O-eNB, a Non-Real Time RAN Intelligent Controller (“Non-RT RIC”), a Real-Time RAN Intelligent Controller (“RT-RIC”).

In some embodiments, the terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” is not an equivalent term, but instead refers to the part of the QoE configuration consisting of an XML file containing instructions of QoE metrics to be collected etc.

In additional or alternative embodiments, the terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.

In additional or alternative embodiments, the terms “QoE configuration” and “QoE measurement configuration” are used interchangeably. Similarly, the terms “RVQoE configuration” and “RVQoE measurement configuration” are used interchangeably.

In additional or alternative embodiments, the terms “access stratum” and “radio layer” are used interchangeably when referring to a UE.

Some embodiments herein are associated with the example of a UE in dual connectivity, but other embodiments may apply to radio access technologies where the UE is served by more than two connectivity legs.

Some embodiments apply to NR as well as future RATs such as 6G, with the IAB-MT a parent backhaul link terminating function and the IAB-DU an access service providing function of a relay node.

In some embodiments, the phrase “sending reports to a node” may or may not mean that the node is the consumer (e.g., the end destination of the reports).

In additional or alternative embodiments, the terms “node” and “network node” are used interchangeably herein.

In additional or alternative embodiments, transmission to a MN or transmission to a SN, means using the carriers in the MCG and the carriers in the SCG respectively.

In additional or alternative embodiments, the terms “management-based QoE configuration” and “m-based QoE configuration” are used interchangeably.

In additional or alternative embodiments, the coordination between MN and SN can be accomplished by enhancing the existing XnAP messages or by defining new dedicated messages.

In some embodiments, conditions in relation to an area scope of a management-based QoE configuration, and conditions in relation to a slice scope of a management-based QoE configuration, are often mentioned. However, a management-based QoE configuration may or may not have an area scope and may and may not have a slice scope (i.e. the area scope and the slice scope are optional components of a management-based QoE configuration). Consequently, it should be understood that the described conditions in relation to an area scope apply only if the management-based QoE configuration does have an area scope, and the described conditions in relation to a slice scope apply only if the management-based QoE configuration does have a slice scope.

Some embodiments addresses the problem of asynchronous reception of a management-based QoE configuration by the RAN nodes jointly providing dual connectivity (or multi-connectivity) to a UE. Since the roles of MN and SN are not inherently built into the nodes, but rather functional roles assigned to the nodes in the service of certain UE, the description of the asynchronous coordination methods between the MN and the SN are best described with the perspective of a certain UE in a dual connectivity setup, wherein the UE is eligible to receive the management-based QoE configuration (e.g. it fulfills any requirement such as support for QoE). Note, however, that a management-based QoE configuration does not target a specific UE, so similar coordination regarding the same management-based QoE configuration may go on in parallel for different UEs and between different nodes (and wherein the nodes may have different roles in the DC setup).

Some procedures for asynchronous coordination of management-based QoE configuration between the MN and the SN for a certain UE are described for a set of main scenarios, each of which diverges into sub-scenarios, or use cases, which are reflected in the methods described for the respective main scenarios. In all the main scenarios, unless specifically mentioned otherwise, both the MN and the SN have at least one cell in the area scope of the management-based QoE configuration and they both receive the management-based QoE configuration from the OAM system. However, the respective nodes may not know this beforehand-in particular not about the other node-and this lack of knowledge is reflected in some of the proposed procedures.

In some embodiments, the procedures include determining whether the other node has received the management-based QoE configuration, e.g. by requesting the other node to send a notification as soon as it has received the particular management-based QoE configuration or based on lack of a message concerning the management-based QoE configuration from the other node.

In additional or alternative embodiments, the procedures include determining whether the other node will receive the management-based QoE configuration (if it has not already received it). If the node has a complete list of the other node's served cells (including the cells'NCGIs and/or TACs and/or TAIs), the node can compare this information with the definition of the area scope of the management-based QoE configuration to determine whether the other node has at least one cell within the area scope and thus will receive (or has already received) the management-based QoE configuration from the OAM system.

In some examples, the determination may be done a priori (at the Xn setup, NG-RAN node modification, SN addition, SN modification (MN-or SN-initiated)), by introducing the possibility for a gNB to request that a full list of served cells (including their TACs and/or TAIs) is transferred from the other gNB (to remove the option to provide a partial list of served cells the peer gNB otherwise has).

In additional or alternative examples, the determination may be done by requesting the other node to always update the list of cells (and associated NCGIs and/or TACs and/or TAIs when this list is changed), which can be done at any time, e.g. at Xn setup, NG-RAN node modification, SN addition, SN modification (MN-or SN-initiated).

In additional or alternative examples, the determination may be done by requesting the full list of served cells when the need arises (where only cell identifiers (and associated TACs and/or TAIs) which have not previously been transferred need to be transferred).

In additional or alternative examples, the determination may be done by inquiring the other node if it has a cell within the area scope (where the inquiry message may include the area scope definition and/or the QoE reference).

In additional or alternative embodiments, the procedures include waiting for the management-based QoE configuration to arrive at the other node and starting a timer that governs the maximum time the node will wait. This is mainly relevant for the node that has the main responsibility for the coordination, i.e., the MN.

In additional or alternative embodiments, the procedures include determining whether the UE is within the area scope (and/or in the slice scope) in the other node. This may be done by determining whether the UE is connected in a cell within the area scope in the other node.

In some examples, the determination is performed by requesting the cell identifier or TAC (or TAI) of the cell(s) the UE is connected in in the other node (e.g. in the MN). In additional or alternative examples, the determination is performed by inquiring the other node if the UE is connected in a cell in the other node which belongs to the area scope. In additional or alternative examples, the determination is performed by knowing from the UE context (e.g. assuming that the UE's context information in the MN contains the identifier(s) of the SCG cell(s) the UE is connected in and that this information can be compared with the area scope definition of the management-based QoE configuration.

Embodiments associated with the MN receiving the management-based QoE configuration before the SN are described below.

In some embodiments, the MN of a certain UE receives a management-based QoE configuration before the SN. The MN may deduce this, or may assume this, based on that it has not received any message from the SN regarding the concerned management-based QoE configuration (whereas it may or may have not requested earlier the SN to notify it once it has received a management-based QoE configuration). At this point, the MN may or may not know whether the SN has a cell within the area scope of the management-based QoE configuration, depending on the MN's knowledge of the cell identifiers and/or TACs (depending on whether the area scope is defined as a list of cells (NCGIs) or a list of tracking areas (TACs)) of the SCG cells in the SN. If the MN does not know, it has the option to inquire the SN to find out as described above.

The MN has the option to decide—without, or prior to, any coordination with the SN—to send the management-based QoE configuration to the UE. Otherwise, when the MN knows that the SN has at least one cell in the area scope, and that the SN consequently (at least in typical cases) will receive the management-based QoE configuration, the MN may choose to wait for the SN to receive the management-based QoE configuration and the MN may set a timer that governs the maximum time the MN will wait. If this timer expires, the MN may skip the coordination with the SN and either decide to send the management-based QoE configuration to the UE (and then do so) or decide not to send the management-based QoE configuration to the UE (e.g. because the MN has already sent the management-based QoE configuration to sufficiently many other UEs). As another option, the MN may instruct the SN to set a timer for a certain duration. If, before the expiry of that timer, the SN does not receive the management-based QoE configuration, the SN should consider that it is not allowed to configure the UE.

If the timer does not expire, because the SN receives the management-based QoE configuration and informs the MN (e.g. expressing interest to send the management-based QoE configuration to the UE or just informing the MN that the management-based QoE configuration has arrived) before the timer expires, the coordination actions as being specified in 3GPP can begin, e.g. involving that the MN decides, based on internal considerations and information received from the SN (e.g. an indication that the SN is interested in sending the management-based QoE configuration to the UE), whether the MN or the SN (or none of them) should send the management-based QoE configuration to the UE.

Alternatively, the absence of a message from the SN regarding the concerned management-based QoE configuration does not necessarily imply that the SN has not received the management-based QoE configuration. Instead, the SN may for instance have received the management-based QoE configuration but is not interested in sending it to the concerned UE, e.g., because the UE is not connected in an SCG cell that is within the area scope of the management-based QoE configuration or because the SN has selected sufficiently many other UEs to send the management-based QoE configuration to. With this alternative, in the absence of a message from the SN regarding the concerned management-based QoE configuration, the MN may still set a timer as described above, assuming that the SN may not have received the management-based QoE configuration yet (and considering that the management-based QoE configuration is not time-critical). Thereafter the method proceeds as above.

As another alternative, instead of waiting for the SN to receive the management-based QoE configuration, and setting a timer accordingly, the MN inquires the SN, as previously described, to find out whether the SN has a cell within the area scope and whether the UE is connected in an SCG cell within the area scope. If this is not the case, the MN may proceed to decide whether to send the management-based QoE configuration to the UE (and then do so) or not to send the management-based QoE configuration to the UE. On the other hand, if the MN finds that the UE is connected in an SCG cell that is within the area scope, then the MN may immediately instruct the SN (e.g. using another inter-gNB message, e.g. an XnAP message) to send the management-based QoE configuration to the UE, either immediately (if the SN already has received the management-based QoE configuration from the OAM system), or as soon as the SN receives the management-based QoE configuration from the OAM system. In the message carrying this instruction, the MN includes the QoE reference of the management-based QoE configuration and optionally also the definition of the area scope of the management-based QoE configuration and possibly other related information, such as the slice scope and available RVQoE metrics.

Furthermore, if the UE is not connected in an MCG cell that is within the area scope, the MN may refrain from any actions (including setting a timer) with regards the handling of this management-based QoE configuration in relation to the concerned UE, until it receives (and if it receives) a message from the SN regarding the concerned management-based QoE configuration and the concerned UE. In this case, the MN may indicate to the SN that the SN can perform any needed action with respect to configuring the UE with QoE measurements in accordance with the management-based QoE configuration.

As a further variation, if the UE is not connected in an MCG cell that is within the area scope, the MN may notify/inquire the SN to find out if the SN is interested in configuring the same UE according to a common management-based QoE configuration received at the MN and SN side. In return, the MN may receive an indication from the SN that the SN is interested in configuring the UE, with a request for the MN to send the (common) management-based QoE configuration to the UE. In this process, the MN can optionally set a timer, to wait for the response from the SN.

Embodiments associated with the SN receiving the management-based QoE configuration before the MN and the SN is interested in sending the management QoE configuration to the UE are described below.

In some embodiments, when the SN receives a management-based QoE configuration and is interested in sending it to the concerned UE (for which it is acting as a SN), the SN sends a message to the MN informing the MN that the SN has received the management-based QoE configuration and that the SN is interested in sending it to the UE. This message may preferably include the QoE reference of the management-based QoE configuration and may optionally also include the definition of the area scope of the management-based QoE configuration and possibly other related information, such as the slice scope and available RVQoE metrics.

When the MN receives this message from the SN, it may choose to proceed immediately to decide whether the SN should (or is allowed to) send the management-based QoE configuration to the UE and then return a message to the SN to inform the SN of the MN's decision. The SN would then act in accordance with the indicated decision (i.e. either send or not send the management-based QoE configuration to the UE).

Alternatively, the MN may choose to wait for itself to receive the management-based QoE configuration and the MN may set a timer that governs the maximum time the MN will wait. If this timer expires, the MN may stop waiting and instead proceed, as described above, to decide whether the SN should (or is allowed to) send the management-based QoE configuration to the UE and then return a message to the SN to inform the SN of the MN's decision. Alternatively, the MN may instruct the SN to set a timer for a certain duration. If, before the expiry of that timer, the SN receives no indication that the MN has received the management-based QoE configuration, the SN may consider that it should configure the UE or is allowed to configure the UE with the management-based QoE configuration.

If the message from the SN included the definition of the area scope of the management-based QoE configuration (and/or the slice scope of the management-based QoE configuration), the MN may base its choice of whether to wait for the management-based QoE configuration to arrive from the OAM system to the MN on the definition of the area scope in relation to the MN's served cells and associated TACs (and/or on the MN's supported network slices in relation to the slice scope). For instance, if the none of the MN's cells is within the area scope, the MN knows that it will not receive the management-based QoE configuration from the OAM system and consequently the MN chooses not to wait for it. As another example, even if the MN has one or more cell(s) within the area scope, it may choose not to wait for the management-based QoE configuration to arrive from the OAM system, e.g. because the UE is currently not connected in an MCG cell that is within the area scope. On the other hand, if the MN determines that the UE is currently connected in an MCG cell that is within the area scope, this may trigger the MN to choose to wait for the management-based QoE configuration to arrive from the OAM system, and optionally start a timer that governs the maximum time it will wait.

When the MN receives the management-based QoE configuration from the OAM system, or when the timer expires, or when the MN decides not to wait for the management-based QoE configuration to arrive from the OAM system, the coordination between the MN and the SN can proceed with the coordination actions as being specified in 3GPP, e.g. involving that the MN decides, based on internal considerations and information received from the SN, whether the MN or the SN (or none of them) should send the management-based QoE configuration to the UE.

In additional or alternative embodiments, when the MN receives the management-based QoE configuration from the OAM system, or when the timer expires (after the SN received the management-based QoE configuration and informed the MN), or when the MN decides not to wait for the management-based QoE configuration to arrive from the OAM system, the MN may request the management-based QoE configuration from the SN and use it to initiate the coordination between the MN and the SN and the coordination between the MN and the SN can proceed with the coordination actions as being specified in 3GPP, e.g. involving that the MN decides, based on internal considerations and information received from the SN, whether the MN or the SN (or none of them) should send the management-based QoE configuration to the UE.

In additional or alternative embodiments, when the SN sends the message to the MN informing the MN that the SN has received the management-based QoE configuration and that the SN is interested in sending it to the UE, the SN includes the complete management-based QoE configuration in the message. This way the MN does not have to request it, if it decides to use it to proceed with the coordination, as described above. Optionally, in conjunction with the SN addition procedure, the MN may configure, request or instruct the SN to include the complete management-based QoE configuration in the above-described message, in case this situation should arise.

Embodiments associated with the SN receiving the management-based QoE configuration before the MN and the SN not being interested in sending the management-based QoE configuration to the UE are described below.

In some embodiments, the SN receives the management-based QoE configuration and determines that it is not interested in sending it to the concerned UE. Reasons for this choice may be that the UE's SCG cell(s) is(are) outside the area scope of the management-based QoE configuration, or that the SN has already sent the management-based QoE configuration to sufficiently many UEs or that the SN prefers to select other UEs for this management-based QoE configuration.

In additional or alternative embodiments, the SN then remains “silent”, i.e., it does not inform the MN that it has received the management-based QoE configuration and in particular does not inform the MN that the SN is not interested in sending the management-based QoE configuration to the UE.

In additional or alternative embodiments, the SN sends a message to the MN to inform the MN that the SN has received the management-based QoE configuration and that the SN is not interested in sending it to the UE. In this message the SN should preferably include the QoE reference of the management-based QoE configuration and optionally also the area scope definition, the NCGI(s) of the UE's SCG cell(s), the TAC(s) of the UE's SCG cell(s), and/or the reason for not being interested in sending the management-based QoE configuration to the UE (e.g. that the UE's SCG cell(s) is(are) outside the area scope of the management-based QoE configuration, or that the SN has already selected, or will select, other UEs for this management-based QoE configuration). The SN may decide to send this message based on knowledge that the MN has at least one cell within the area scope, and/or on knowledge of the MN's knowledge of the SN's cells and TACs (e.g. if the SN knows that the MN can determine if the SN will receive the management-based QoE configuration and thus may be waiting for the SN to receive it so that the coordination can start).

In additional or alternative embodiments, upon receiving this message from the SN, the MN may wait for the management-based QoE configuration to arrive from the OAM system (unless area scope definition information in the message from the SN indicates that the MN does not have any cell within the area scope and consequently will not receive the management-based QoE configuration from the OAM system), and when the management-based QoE configuration arrives from the OAM system, the MN may decide whether or not to send the management-based QoE configuration to the UE (and send it to the UE in case it decides to do so).

In additional or alternative embodiments, if the UE is not connected in an SCG cell that is within the area scope, the SN may notify/inquire the MN to find out if the MN is interested in configuring the same UE according to a common management-based QoE configuration received at the SN and at the MN. In return, the SN may receive an indication from the MN that the MN is interested in configuring the UE, with a request for the SN to send the (common) management-based QoE configuration to the UE. In this process, the SN can optionally set a timer, to wait for MN response.

In additional or alternative embodiments, the MN may decide to instruct the SN to send the management-based QoE configuration to the UE despite that the SN has indicated no interest in doing so (provided that the UE is connected in a SCG cell that is within the area scope). If using this option, the MN does not have to wait for the management-based QoE configuration to arrive from the OAM system, but may make the decision immediately upon receiving the message from the SN.

Embodiments associated with the UE's gNB (which is soon to be the UE's MN) receiving a management-based QoE configuration and subsequently adding a SN (and itself becomes the MN) to the establish DC for the UE are describe below.

In some embodiments, a UE is in single connectivity mode and its serving gNB has received a management-based QoE configuration, and subsequently (after a non-negligible time) the UE's serving gNB adds a SN (and thus itself becomes the MN). This may be divided into several sub-scenarios, for which the methods can be described in a way that makes it easier to overview the various variations and options.

In some examples, the MN has sent the management-based QoE configuration to the UE and informs the SN accordingly. In additional or alternative examples, the sending of the management-based QoE configuration to the UE has already been performed, and thus the only remaining “coordination” is that the SN is informed that it is not allowed to send the management-based QoE configuration to the UE. As one option, the MN may send this information in a S-NODE ADDITION REQUEST XnAP message.

In additional or alternative examples, the MN has sent the management-based QoE configuration to the UE, but does not inform the SN. The SN expresses interest in sending the management-based QoE configuration to the UE. When the MN in this example receives the message (e.g. an S-NODE ADDITION REQUEST ACKNOWLEDGE XnAP message) from the SN where the SN expresses interest in sending the management-based QoE configuration to the UE, the MN responds with the instruction to the SN to not send the management-based QoE configuration to the UE. In this message, the MN may optionally also indicate that the MN has sent the management-based QoE configuration to the UE.

In additional or alternative examples, the MN has sent the management-based QoE configuration to the UE, but does not inform the SN. The SN does not express interest (e.g. explicitly expresses lack of interest) in sending the management-based QoE configuration to the UE. In additional or alternative examples, any further coordination action would be redundant, since the two nodes in practice are in agreement and aligned (i.e. the SN is not interested in sending the management-based QoE configuration to the UE and the MN has sent the management-based QoE configuration to the UE).

In additional or alternative examples, The MN has not sent the management-based QoE configuration to the UE and informs the SN accordingly. The SN expresses interest in sending the management-based QoE configuration to the UE. In additional or alternative examples, the MN has chosen not to send the management-based QoE configuration to the UE and receives a message, e.g. an S-NODE ADDITION REQUEST ACKNOWLEDGE XnAP message, from the new SN in which the new SN indicates that it is interested in sending the management-based QoE configuration to the UE. The MN may then decide to let the SN send the management-based QoE configuration to the UE (and instruct the SN to do so), or may decide to not let the SN send the management-based QoE configuration to the UE (and instruct the SN accordingly)

In additional or alternative examples, the MN has not sent the management-based QoE configuration to the UE and informs the SN accordingly. The SN does not express interest (e.g. explicitly expresses lack of interest) in sending the management-based QoE configuration to the UE. In additional or alternative examples, the SN is not interested in sending the management-based QoE configuration to the UE, and since the MN has not already sent the management-based QoE configuration to the UE, the MN is assumedly not interested in doing this either. Hence, no further coordination is needed.

In additional or alternative examples, the MN has not sent the management-based QoE configuration to the UE and does not inform the SN. The SN expresses interest in sending the management-based QoE configuration to the UE. In additional or alternative examples, the MN has chosen not to send the management-based QoE configuration to the UE and receives a message, e.g. an S-NODE ADDITION REQUEST ACKNOWLEDGE XnAP message, from the SN, wherein SN indicates that it is interested in sending the management-based QoE configuration to the UE. Typically, the MN would in this case allow the SN to send the management-based QoE configuration to the UE and instruct the SN to do so, but the MN also has the option to instruct the SN to not send the management-based QoE configuration to the UE.

In additional or alternative examples, the MN has not sent the management-based QoE configuration to the UE and does not inform the SN. The SN does not express interest (e.g. explicitly expresses lack of interest) in sending the management-based QoE configuration to the UE. In additional or alternative examples, the SN is not interested in sending the management-based QoE configuration to the UE, and since the MN has not already sent the management-based QoE configuration to the UE, the MN is assumedly not interested in doing this either. Hence, no further coordination is needed.

In additional or alternative examples, the MN has not sent the management-based QoE configuration to the UE and instructs the SN to send the management-based QoE configuration to the UE. In additional or alternative examples, the MN knows that the SN has cell(s) within the area scope of the management-based QoE configuration, and knows that the UE is connected to an SCG cell that is within the area scope. The MN may know this inherently because it is in control of the SN addition procedure. The MN preferably uses a S-NODE ADDITION REQUEST XnAP message to convey this instruction.

Embodiments associated with the MN receiving a management-based QoE configuration and subsequently changing the SN in the DC setup for the UE are described below.

In some embodiments, if the old SN does not have any cell within the area scope of the management-based QoE configuration (or does not support the network slice(s) in the slice scope of the management-based QoE configuration), but the new SN does have at least one cell within the area scope of the management-based QoE configuration (and does support a network slice in the slice scope of the management-based QoE configuration). Consequently, some of the operations described above apply also to this case.

In additional or alternative embodiments, the old SN has at least one cell within the area scope of the management-based QoE configuration (and supports a network slice in the slice scope of the management-based QoE configuration), but the UE is not connected in a SCG cell that is within the area scope (or the UE is not connected in a SCG cell that supports the slice(s) in the slice scope the UE is using), but in the new SN, the UE is connected in a SCG cell that is within the area scope (and supports a network slice the UE is using in the slice scope), then the MN's actions may depend on whether these circumstances in the old SN/SCG applied when the coordination with regards to the management-based QoE configuration occurred between the MN and the old a SN. If this was the case, then choosing to let the old SN send the management-based QoE configuration to the UE was at that time not an option for the MN, whereas the option to let the new SN send the management-based QoE configuration to the UE is available. However, if the circumstances when the coordination with regards to the management-based QoE configuration occurred between the MN and the old SN where different, such that the UE was connected in a SCG cell within the area scope of the management-based QoE configuration (and which supported a network slice the UE was using in the slice scope of the management-based QoE configuration), then it can be assumed that the MN has made its decision with regards to MN-SN coordination for this management-based QoE configuration and the MN may then let the mobility procedure handle the management-based QoE configuration such that the situation in the new SN becomes the same as in the old SN for the concerned UE.

Some additional mechanisms which may facilitate inter-node coordination of management-based QoE configurations

As an extension that applies to all the above explained scenarios, in another alternative, the management-based QoE configuration sent from the OAM system can be extended with an indication about other nodes that have received or will receive the same management-based QoE configuration, such as gNB ID, NCGI, NCGI list, TAC, TAC list, TAI, TAI list, in addition to other parameters that might be used to configure the coordination, such as timeouts. The indication of other nodes may be explicit (e.g., gNB ID) or implicit.

In another alternative, the OAM system indicates together with the QoE configurations it sends to the RAN nodes, the time from which the QoE configurations become valid. The reason is to allow that the configurations are valid once all intended RAN nodes (e.g., all RAN nodes in area scope) have received the configuration.

Various embodiments above were described in terms of QoE, considering that the circumstance that motivates the development of the solution is that QoE configurations may be asynchronously received by gNBs acting as MN and SN for a UE. Nevertheless, the solution may also be extended to apply also to RAN Visible QoE (RVQoE). Even though RVQoE configurations are not sent from the OAM system to the RAN, but are rather created in the RAN, creation of a RVQoE configuration depends on a corresponding QoE configuration, as well as information from the OAM system about available RVQoE metrics.

Hence, the previously described methods supporting asynchronous coordination of management-based QoE configuration may apply to the corresponding RVQoE configuration too, and may also be extended with features that specifically address coordination of RVQoE configuration.

In some embodiments, the decision and instruction regarding which node that sends the management-based QoE configuration to the UE also applies to RVQoE configuration, i.e. the same node creates the RVQoE configuration and sends it to the UE.

In additional or alternative embodiments, the message from the MN to the SN, instructing the SN to either send the management-based QoE configuration to the UE or not to send the management-based QoE configuration to the UE, also includes a separate instruction concerning RVQoE configuration corresponding to the management-based QoE configuration, wherein this instruction could be either of:

In additional or alternative embodiments, the SN should create a RVQoE configuration and send it to the UE. Optionally, the instruction also include that the SN should send the RVQoE configuration to the MN.

In additional or alternative embodiments, the SN should create a RVQoE configuration and send it to the MN. (The MN will then send the RVQoE configuration to the UE, optionally after having modified it, e.g. by merging it with a RVQoE configuration created by the MN.)

In additional or alternative embodiments, the SN should not create a RVQoE configuration.

In additional or alternative embodiments, the SN should not create a RVQoE configuration, but the SN should forward to the UE a RVQoE configuration sent from the MN together with the instruction. This may alternatively be formulated as, the instruction message includes a RVQoE configuration that the SN should forward to the UE.

In additional or alternative embodiments, the instruction message includes a RVQoE configuration that the SN should modify (if desired), e.g. by including further RVQoE metrics suiting the SN's purposes, or by merging it with a RVQoE configuration created by the SN. After the possible modification, the SN should send the RVQoE configuration to the UE.

In additional or alternative embodiments, the SN should set up SRB(s) to receive RVQoE reports corresponding to a RVQoE configuration prepared by the MN based on the received (common) management-based QoE configuration. The RVQoE configuration, as prepared by the MN (and optionally modified by the SN), can be sent to the UE by the MN or the SN.

In additional or alternative embodiments, if, e.g., via the received RVQoE reports, the SN determines that the MN carries the data for the application session, the SN should inform the MN accordingly and forward the reports to the MN.

In additional or alternative embodiments, the SN should forward future RVQoE reports corresponding to an RVQoE configuration prepared by the MN based on the received (common) management-based QoE configuration.

In additional or alternative embodiments, given that a management-based QoE configuration does not target a specific UE, but rather all or any of the UEs that are served by the RAN nodes receiving the management-based QoE configuration (and fulfill other applicable criteria e.g. area scope, slice scope, support for QoE measurements of the concerned service type), all or some considerations in this invention presented for a single UE are also applicable to a group of UEs. In this case, the coordination signaling proposed in this invention pertains to multiple UEs, where these UEs may be referred to explicitly (e.g., via identifiers of these UEs) or implicitly.

In additional or alternative embodiments, tin addition to area scope, the QoE configuration delivered to the RAN may also contain the Slice Support List IE, containing the list of slices for which the QoE measurements are to be executed. In other words, this list can be considered a “slice scope”, so, if the slice scope is present in the QoE configuration, the UE may execute the measurements only if it is both in area scope AND in the slice scope, or alternatively only if it is in the slice scope (in case no area scope is present). Therefore, the methods proposed herein for area scope (e.g. methods including conditions related to an area scope) could be applied in a similar way when the slice scope is considered either instead of the area scope or combined with the area scope.

In additional or alternative embodiments, an area scope, the QoE configuration delivered to the RAN may also contain information related to a list of MBS related identifier(s) such as MBS Session ID(s) (e.g. a list of TMGIs), and/or a list of cells (e.g. NCGIs) and/or Tracking Area Identities, defining a MBS Session scope, according to which the QoE measurements are to be executed. If such an MBS Session scope is present in the QoE configuration, the UE may execute the measurements only if it is both in the area scope AND in the MBS session scope, or alternatively only if it is in the MBS session scope (in case no area scope is present). Therefore, the methods proposed herein for area scope (e.g. methods including conditions related to an area scope) could be applied in a similar way when the MBS Session scope is considered either instead of the area scope or combined with the area scope.

In additional or alternative embodiments, the validity of all the indications and/or decisions described in this invention may be either permanent or time-limited. In the latter case, the limitation of validity may be ensured by updating the previous indications/intentions/instructions, or by setting validity timers. An example of such an indication/decision is e.g., which node may send the concerned management-based QoE measurements to the UE.

In some examples, the expiry of such a validity timer may mean that the corresponding indication/decision is not valid anymore (and thus a new coordination is needed), or that the opposite of the indication/decision is valid from now on.

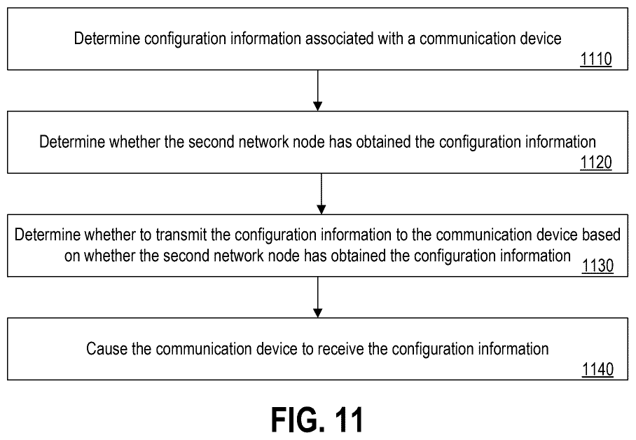

FIG. 11 illustrates operations performed by a first network node in a communications network that includes a second network node, the first network node and the second network node providing DC for a communication device.

At block 1110, the operations include determining configuration information associated with a communication device. In some embodiments, the configuration information includes at least one of: management-based QoE configuration; and RVQoE, configuration.

At block 1120, the operations include determining whether the second network node has obtained the configuration information. In some embodiments, determining whether the second network node has obtained the configuration information includes receiving an indication of whether the second network node has obtained the configuration information from the second network node.

In additional or alternative embodiments, determining whether the second network node has obtained the configuration information includes determining whether the second network node will receive the configuration information. In some examples, determining whether the second network node will receive the configuration information includes determining whether at least one cell associated with the second network node is within an area scope of the configuration information. In additional or alternative examples, determining whether the at least one cell associated with the second network node is within an area scope of the configuration information includes receiving a list of cells associated with the second network node during at least one of: a Xn setup; a network node modification; a secondary node, SN, addition; and a SN modification. In additional or alternative examples, determining whether the at least one cell associated with the second network node is within an area scope of the configuration information includes requesting the second network node provide a list of cells associated with the second network node. In additional or alternative examples, determining whether the at least one cell associated with the second network node is within an area scope of the configuration information includes requesting an indication of whether the second network node has cell within the area scope from the second network node.

In additional or alternative embodiments, determining whether the second network node will receive the configuration information includes determining that the second network node will receive the configuration information. Determining whether the second network node has received the configuration information further includes, subsequent to determining that the second network node will receive the configuration information, initiating a timer based on a maximum amount of time the first network node will wait for the second network node to receive the configuration information. In some examples, determining whether the second network node has obtained the configuration information associated with the communication device includes determining that the second network node has not obtained the configuration information in response to expiration of the timer. Determining whether to transmit the configuration information associated with the communication device includes determining whether to transmit the configuration information associated with the communication device based on the timer expiring. In additional or alternative examples, determining whether the second network node has received the configuration information includes determining that the second network node has not received the configuration information based on having not received an indication that the second network node has obtained the configuration information within a period of time of the first network node determining the configuration information.

At block 1130, the operations include determining whether to transmit the configuration information to the communication device based on whether the second network node has obtained the configuration information. In some embodiments, determining whether to transmit the configuration information to the communication device includes: determining whether the communication device is within an area scope and/or slice scope of the second network node; and determining whether to transmit the configuration information to the communication device based on whether the communication device is within the area scope and/or the slice scope of the second network node.

At block 1140, the operation include causing the communication device to receive the configuration information. In some embodiments, determining whether to transmit the configuration information to the communication device includes determining to transmit the configuration information to the communication device. Causing the communication device to receive the configuration information includes transmitting the configuration information to the communication device.

In additional or alternative embodiments, determining whether to transmit the configuration information to the communication device includes determining to not transmit the configuration information to the communication device. Causing the communication device to receive the configuration information includes transmitting instructions to the second network node to transmit the configuration information to the communication device.

In additional or alternative embodiments, the first network node is a master node, MN, and the second network node is a secondary node, SN. Determining whether to transmit the configuration information to the communication device includes determining whether to transmit the configuration information to the communication device based on the first network node being the MN and the second network node being the SN.

In additional or alternative embodiments, the first network node is a secondary node, SN, and the second network node is a master node, MN. Determining whether to transmit the configuration information to the communication device includes determining whether to transmit the configuration information to the communication device based on the first network node being the SN and the second network node being the MN.

Various operations from the flow chart of FIG. 11 may be optional with respect to some embodiments of RAN nodes and related methods. For example, in regards to Example Embodiment 1 (below) blocks 1110 and 1140 may be optional.

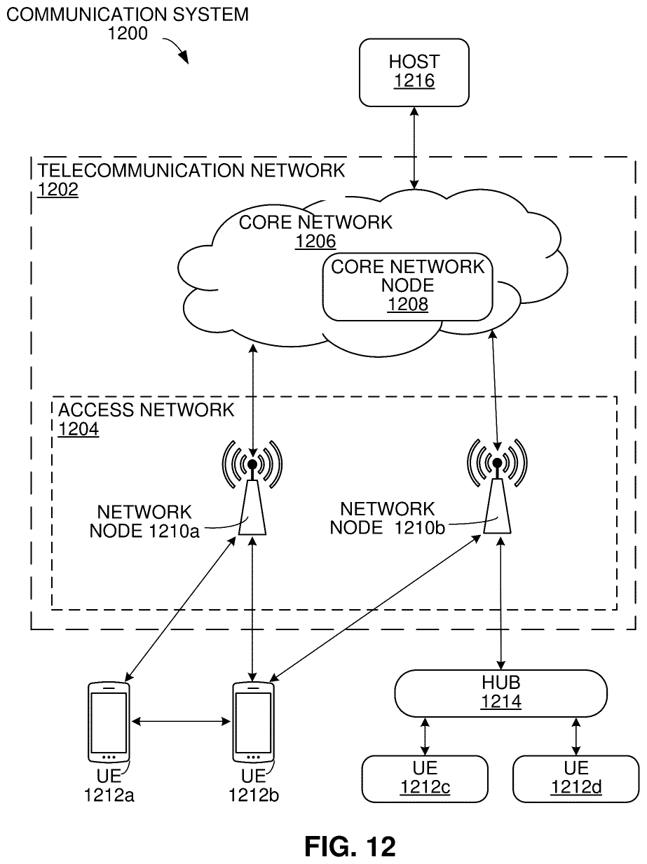

Although FIG. 12 is described in regards to a RAN node, any suitable network node may perform the operations. For example, the operations may be performed by the Core Network CN node 1400 (implemented using the structure of FIG. 14), a central unit, a distributed unit, a central unit control plane, or a central unit user plane.

Herin the terms “or” and “and/or” are sometimes you interchangeably.

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub-that is, a hub whose primary function is to route communications to/from the UEs from/to the network node 1210b. In other embodiments, the hub 1214 may be a non-dedicated hub-that is, a device which is capable of operating to route communications between the UEs and network node 1210b, but which is additionally capable of operating as a communication start and/or end point for certain data channels.

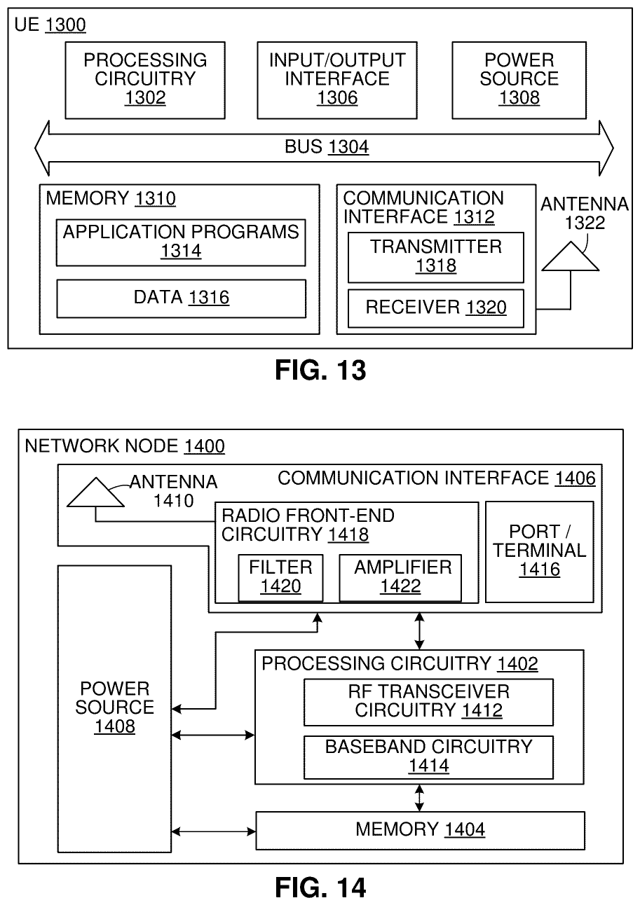

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

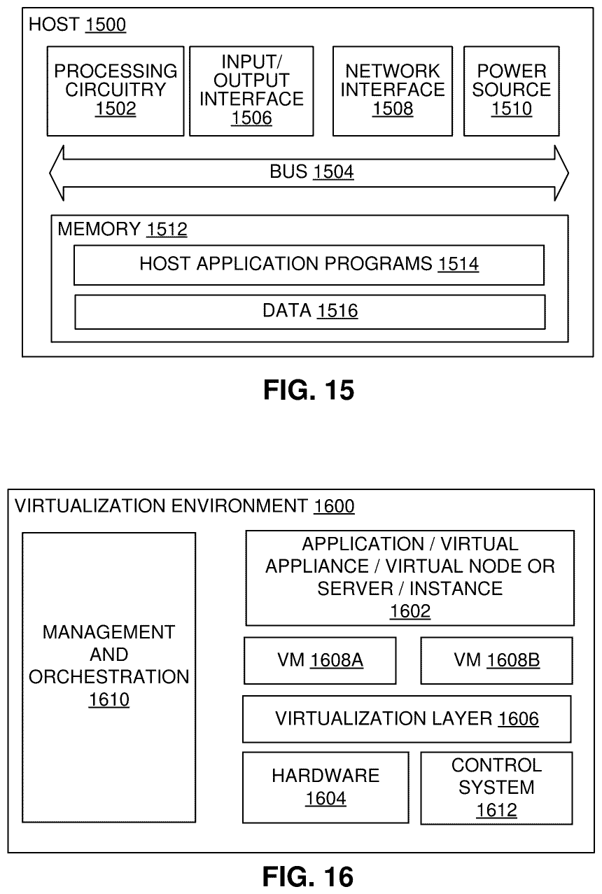

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top (OTT) services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

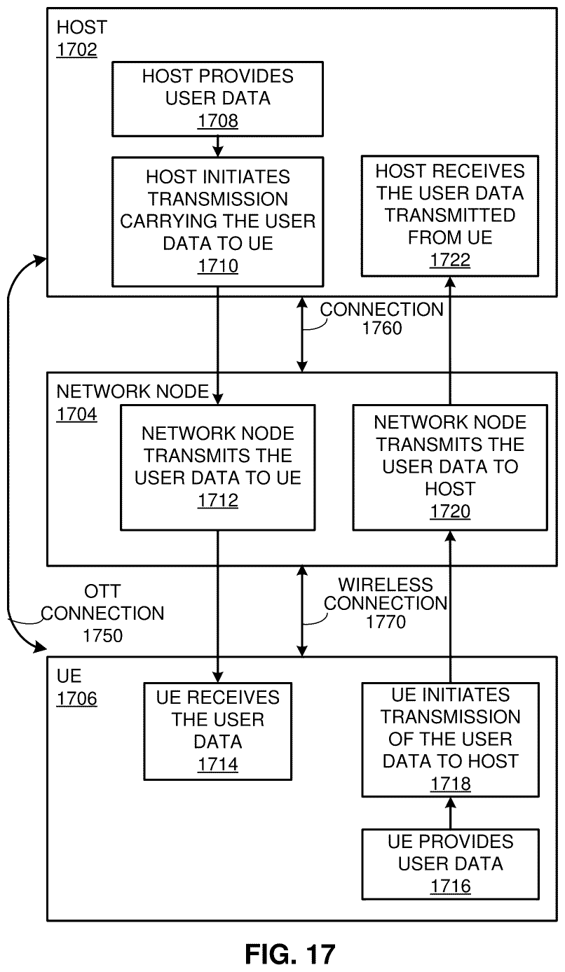

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may improve data rate and/or latency and thereby provide benefits such as reduced user waiting, better responsiveness, and improved user experience.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc. ; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments are described below.
Embodiment 1. A method of operating a first network node in a communications network that includes a second network node, the first network node and the second network node providing dual connectivity, DC, for a communication device, the method comprising:
determining (1120) whether the second network node has obtained configuration information associated with the communication device; and
determining (1130) whether to transmit the configuration information associated with the communication device based on whether the second network node has obtained the configuration information.
Embodiment 2. The method of Embodiment 1, wherein the configuration information comprises at least one of:
management-based quality of experience, QoE, configuration; and
radio access network visible QoE, RVQoE, configuration.
Embodiment 3. The method of any of Embodiments 1-2, wherein determining whether the second network node has obtained the configuration information comprises receiving an indication of whether the second network node has obtained the configuration information from the second network node.
Embodiment 4. The method of any of Embodiments 1-3, wherein determining whether the second network node has obtained the configuration information comprises determining whether the second network node will receive the configuration information.
Embodiment 5. The method of Embodiment 4, wherein determining whether the second network node will receive the configuration information comprises determining whether at least one cell associated with the second network node is within an area scope of the configuration information.
Embodiment 6. The method of Embodiment 5, wherein determining whether the at least one cell associated with the second network node is within an area scope of the configuration information comprises receiving a list of cells associated with the second network node during at least one of: a Xn setup; a network node modification; a secondary node, SN, addition; and a SN modification.
Embodiment 7. The method of any of Embodiments 5-6, wherein determining whether the at least one cell associated with the second network node is within an area scope of the configuration information comprises requesting the second network node provide a list of cells associated with the second network node.
Embodiment 8. The method of any of Embodiments 5-7, wherein determining whether the at least one cell associated with the second network node is within an area scope of the configuration information comprises requesting an indication of whether the second network node has cell within the area scope from the second network node.
Embodiment 9. The method of any of Embodiments 5-8, wherein determining whether the second network node will receive the configuration information comprises determining that the second network node will receive the configuration information,
wherein determining whether the second network node has received the configuration information further comprises:
   subsequent to determining that the second network node will receive the configuration information, initiating a timer based on a maximum amount of time the first network node will wait for the second network node to receive the configuration information.
Embodiment 10. The method of Embodiment 9, wherein determining whether the second network node has obtained the configuration information associated with the communication device comprises determining that the second network node has not obtained the configuration information in response to expiration of the timer, and
wherein determining whether to transmit the configuration information associated with the communication device comprises determining whether to transmit the configuration information associated with the communication device based on the timer expiring.
Embodiment 11. The method of any of Embodiments 1-10, further comprising:
determining (1110) the configuration information associated with the communication device,
wherein determining whether the second network node has received the configuration information comprises determining that the second network node has not received the configuration information based on having not received an indication that the second network node has obtained the configuration information within a period of time of the first network node determining the configuration information.
Embodiment 12. The method of any of Embodiments 1-11, wherein determining whether to transmit the configuration information to the communication device comprises:
determining whether the communication device is within an area scope and/or slice scope of the second network node; and
determining whether to transmit the configuration information to the communication device based on whether the communication device is within the area scope and/or the slice scope of the second network node.
Embodiment 13. The method of any of Embodiments 1-12, wherein determining whether to transmit the configuration information to the communication device comprises determining to transmit the configuration information to the communication device,
the method further comprising:
   transmitting (1140) the configuration information to the communication device.
Embodiment 14. The method of any of Embodiments 1-12, wherein determining whether to transmit the configuration information to the communication device comprises determining not to transmit the configuration information to the communication device,
the method further comprising:
   transmitting (1140) instructions to the second network node to transmit the configuration information to the communication device.
Embodiment 15. The method of any of Embodiments 1-14, wherein the first network node is a master node, MN, and
wherein the second network node is a secondary node, SN.
Embodiment 16. The method of Embodiment 15, wherein determining whether to transmit the configuration information to the communication device comprises determining whether to transmit the configuration information to the communication device based on the first network node being the MN and the second network node being the SN.
Embodiment 17. The method of any of Embodiments 1-14, wherein the first network node is a secondary node, SN, and
wherein the second network node is a master node, MN.
Embodiment 18. The method of Embodiment 17, wherein determining whether to transmit the configuration information to the communication device comprises determining whether to transmit the configuration information to the communication device based on the first network node being the SN and the second network node being the MN.
Embodiment 19. A network node (1400), the network node comprising:
processing circuitry (1402); and
memory (1404) coupled to the processing circuitry and having instructions stored therein that are executable by the processing circuitry to cause the network node to perform operations comprising any of the operations of Embodiments 1-18.
Embodiment 20. A computer program comprising program code to be executed by processing circuitry (1402) of a network node (1400), whereby execution of the program code causes the network node to perform operations comprising any operations of Embodiments 1-18.
Embodiment 21. A computer program product comprising a non-transitory storage medium (1404) including program code to be executed by processing circuitry (1402) of a network node (1400), whereby execution of the program code causes the network node to perform operations comprising any operations of Embodiments 1-18.
Embodiment 22. A non-transitory computer-readable medium having instructions stored therein that are executable by processing circuitry (1402) of a network node (1400) configured to perform operations comprising any of the operations of Embodiments 1-18.
Embodiment 23. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
   determining (1120) whether the second network node has obtained configuration information associated with the communication device; and
   determining (1130) whether to transmit the configuration information associated with the communication device based on whether the second network node has obtained the configuration information.
Embodiment 24. The host of the previous embodiment, wherein:
the processing circuitry of the host is configured to execute a host application that provides the user data; and
the UE comprises processing circuitry configured to execute a client application associated with the host application to receive the transmission of user data from the host.
Embodiment 25. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the following operations to transmit the user data from the host to the UE:
   determining (1120) whether the second network node has obtained configuration information associated with the communication device; and
   determining (1130) whether to transmit the configuration information associated with the communication device based on whether the second network node has obtained the configuration information.
Embodiment 26. The method of the previous embodiment, further comprising, at the network node, transmitting the user data provided by the host for the UE.
Embodiment 27. The method of any of the previous 2 embodiments, wherein the user data is provided at the host by executing a host application that interacts with a client application executing on the UE, the client application being associated with the host application.
Embodiment 28. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
   determining (1120) whether the second network node has obtained configuration information associated with the communication device; and
   determining (1130) whether to transmit the configuration information associated with the communication device based on whether the second network node has obtained the configuration information.
Embodiment 29. The communication system of the previous embodiment, further comprising:
the network node; and/or
the user equipment.
Embodiment 30. The communication system of the previous 2 embodiments, wherein:
the processing circuitry of the host is configured to execute a host application, thereby providing the user data; and
the host application is configured to interact with a client application executing on the UE, the client application being associated with the host application.
Embodiment 31. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the following operations to receive the user data from the UE for the host:
   determining (1120) whether the second network node has obtained configuration information associated with the communication device; and
   determining (1130) whether to transmit the configuration information associated with the communication device based on whether the second network node has obtained the configuration information.
Embodiment 32. The host of the previous 2 embodiments, wherein:
the processing circuitry of the host is configured to execute a host application, thereby providing the user data; and
the host application is configured to interact with a client application executing on the UE, the client application being associated with the host application.
Embodiment 33. The host of the any of the previous 2 embodiments, wherein the initiating receipt of the user data comprises requesting the user data.
Embodiment 34. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host:
   determining (1120) whether the second network node has obtained configuration information associated with the communication device; and
   determining (1130) whether to transmit the configuration information associated with the communication device based on whether the second network node has obtained the configuration information.
Embodiment 35. The method of the previous embodiment, further comprising at the network node, transmitting the received user data to the host.

1. A method of operating a first network node in a communications network that includes a second network node, the first network node and the second network node providing dual connectivity, DC, for a communication device, the method comprising:
receiving an indication of whether the second network node has obtained configuration information associated with the communication device, the configuration information including quality of experience, QoE, configuration information and/or radio access network visible QoE, RVQoE, configuration information; and
determining whether to transmit the configuration information associated with the communication device based on the indication of whether the second network node has obtained the configuration information.

2. The method of claim 1, wherein determining whether to transmit the configuration information to the communication device comprises determining, by the first network node, to not transmit the configuration information to the communication device,
the method further comprising:
transmitting instructions to the second network node to transmit the configuration information to the communication device.

3. The method of claim 1, wherein receiving the indication of whether the second network node has obtained the configuration information comprises determining whether the second network node may obtain the configuration information.

4. The method of claim 3, wherein determining whether the second network node may obtain the configuration information comprises determining whether at least one cell associated with the second network node is within an area scope specified in the configuration information.

5. The method of claim 4, wherein determining whether the at least one cell associated with the second network node is within an area scope specified in the configuration information comprises receiving a list of cells associated with the second network node during at least one of: a Xn setup; a network node modification; a secondary node, SN, addition; and a SN modification.

6. The method of claim 4, wherein determining whether the at least one cell associated with the second network node is within an area scope specified in the configuration information comprises requesting the second network node to provide a list of cells associated with the second network node.

7. The method of claim 4, wherein determining whether the at least one cell associated with the second network node is within an area scope specified in the configuration information comprises requesting the second network node to provide an indication of whether the second network node has a cell within the area scope.

8. The method of claim 4, wherein determining whether the second network node may receive the configuration information comprises determining that the second network node may receive the configuration information,
wherein receiving the indication of whether the second network node has obtained the configuration information further comprises:
subsequent to determining that the second network node may receive the configuration information, initiating a timer based on a maximum amount of time the first network node will wait for the second network node to receive the configuration information.

9. The method of claim 8, wherein receiving the indication of whether the second network node has obtained the configuration information associated with the communication device comprises determining that the second network node has not obtained the configuration information in response to expiration of the timer, and
wherein determining whether to transmit the configuration information associated with the communication device comprises determining whether to transmit the configuration information associated with the communication device based on the timer expiring.

10. The method of claim 1, further comprising:
determining the configuration information associated with the communication device,
wherein receiving the indication of whether the second network node has received the configuration information comprises determining that the second network node has not received the configuration information based on having not received an indication that the second network node has obtained the configuration information within a period of time of the first network node determining the configuration information.

11. The method of claim 1, wherein determining whether to transmit the configuration information to the communication device comprises determining to transmit the configuration information to the communication device,
the method further comprising:
transmitting the configuration information to the communication device.

12. The method of claim 1, wherein the first network node is a master node, MN, and
wherein the second network node is a secondary node, SN.

13. The method of claim 12, wherein determining whether to transmit the configuration information to the communication device comprises determining whether to transmit the configuration information to the communication device based on the first network node being the MN and the second network node being the SN.

14. The method of claim 1, wherein the first network node is a secondary node, SN, and wherein the second network node is a master node, MN.

15. The method of claim 14, wherein determining whether to transmit the configuration information to the communication device comprises determining whether to transmit the configuration information to the communication device based on the first network node being the SN and the second network node being the MN.

16. The method of claim 1, wherein determining whether to transmit the configuration information to the communication device comprises:
determining whether the communication device is within an area scope and/or slice scope of the second network node; and
determining whether to transmit the configuration information to the communication device based on whether the communication device is within the area scope and/or the slice scope of the second network node.

17.-20. (canceled)

21. A computer program product comprising a non-transitory storage medium including program code to be executed by processing circuitry of a network node, whereby execution of the program code causes the network node to perform operations comprising:
receive an indication of whether the second network node has obtained configuration information associated with the communication device, the configuration information including quality of experience, QoE, configuration information and/or radio access network visible QoE, RVQoE, configuration information; and
determine whether to transmit the configuration information associated with the communication device based on the indication of whether the second network node has obtained the configuration information.

22. The computer program product of claim 21, wherein determine whether to transmit the configuration information to the communication device comprises determine, by the first network node, to not transmit the configuration information to the communication device,
the operations further comprising:
transmit instructions to the second network node to transmit the configuration information to the communication device.

23. A network node the network, node comprising:
processing circuitry; and
memory coupled to the processing circuitry and having instructions stored therein that are executable by the processing circuitry to cause the network node to perform operations comprising:
receive an indication of whether the second network node has obtained configuration information associated with the communication device, the configuration information including quality of experience, QoE, configuration information and/or radio access network visible QoE, RVQoE, configuration information; and
determine whether to transmit the configuration information associated with the communication device based on the indication of whether the second network node has obtained the configuration information.

24. The network node of claim 23, wherein determine whether to transmit the configuration information to the communication device comprises determine, by the first network node, to not transmit the configuration information to the communication device,
the operations further comprising:
transmit instructions to the second network node to transmit the configuration information to the communication device.
